(19) United States
(12) Patent Application Publication
(10) Pub. No.: US 2016/0107325 A1
(43) Pub. Date: Apr. 21, 2016

(54) DEVICE AND METHOD FOR CUTTING FOOD PIECES INTO A TWISTED SHAPE

(71) Applicant: McCain Foods Limited, Florenceville-Bristol (CA)

(72) Inventors: David M. Rogers, Woodstock (CA); John Warren Aikens, New Maryland (CA); Carlos Rincon, Florenceville-Bristol (CA)

(21) Appl. No.: 14/515,107

(22) Filed: Oct. 15, 2014

(51) Int. Cl. B26D 3/11; B26D 3/26; B26D 1/03

(52) U.S. Cl. CPC B26D 3/11; B26D 1/03; B26D 3/26

(57) ABSTRACT

A cutting device for cutting twisted-shape food pieces is disclosed. The cutting device includes at least one tube, the tube having an open inlet end and an open outlet end, wherein the tube defines a longitudinal passage extending from the inlet end to the outlet end. At least three cutting blades are coupled to the tube downstream of the inlet end of the tube. Each cutting blade includes a blade edge facing the inlet end, and each blade edge extends from an upstream edge end to a downstream edge end across a portion of the bore.

### FIELD

This application relates to the field of cutting food products, such as fruit or vegetables.

### INTRODUCTION

This application relates to devices and methods for making cut food products. More particularly, this application relates to devices and methods for cutting food products into food pieces having a twisted shape.

### SUMMARY

In a first aspect, there is a cutting device for cutting twisted-shape food pieces. The cutting device may comprise at least one tube, the tube having an open inlet end and an open outlet end, wherein the tube defines a longitudinal passage extending from the inlet end to the outlet end; and at least three cutting blades coupled to the tube downstream of the inlet end of the tube. Each cutting blade may include a blade edge facing the inlet end, and each blade edge may extend from an upstream edge end to a downstream edge end across a portion of the bore.

In some embodiments, the passage may be cylindrical.

In some embodiments, the cutting blades of the tube may be coupled to the downstream end of the tube.

In some embodiments, the cutting blades of the tube may be integrally formed with the tube.

In some embodiments, the cutting blades of the tube may be formed from an inwardly punched portion of a sidewall of the tube.

In some embodiments, each blade edge of each blade of the tube may have a convex shape relative a longitudinal axis of the tube.

In some embodiments, a downstream distance between the inlet end and the cutting blades may be between 50 mm and 125 mm.

In some embodiments, the at least one tube may include at least six tubes arranged in parallel side-by-side.

In some embodiments, the inlet end of each tube may be aligned in a common plane.

In some embodiments, the passage of the tube may have a diameter of between 6 mm and 20 mm.

In some embodiments, each blade edge may face tangentially in a same circular direction.

In some embodiments, at least a portion of each blade edge may be spaced apart from the longitudinal axis of the tube by less than a radius of the passage of the tube.

In some embodiments, the cutting device may further comprise a base defining an interior opening. Each of the at least one tube may be coupled to the base, and the inlet end of each tube may faces the opening.

In some embodiments, the cutting device may further comprise at least one mounting plate. The mounting plate may have first and second edges, the first edge connected to the tube, and the second edge connected to the base.

In some embodiments, the base may further define a plurality of spaced apart mounting holes distributed around a periphery of the interior opening.

In some embodiments, each tube may extend through the interior opening.

In some embodiments, the base may include an upstream side and a downstream side, and wherein an inlet end of each tube is axially aligned with the upstream side of the base.

In some embodiments, the inlet end of the tube may define an inlet cutting edge.

In another aspect, there is a method of cutting an elongate food piece using a cutting device. The method may comprise moving the food piece from an inlet end of a hollow tube of the cutting device toward an outlet end of the hollow tube, and cutting the food piece with a plurality of cutting blades mounted to the hollow tube. The cutting blades may be positioned downstream of the inlet end. The cutting blades may cut the food piece to define a new cross-sectional shape of the food piece. The cutting blades may apply reactionary forces to the food piece. The reactionary forces may have tangential force components, wherein the reactionary forces imparted by the cutting blades rotate the food piece about a longitudinal axis of the food piece during the moving step.

In some embodiments, the method may further comprise moving a food product through the inlet end, whereby the inlet end cuts the food product to form the food piece.

In some embodiments, the food piece is cylindrical, and the new cross-sectional shape has a plurality of sides.

### DRAWINGS

FIG. 1 shows a perspective view of a system for cutting twisted potato pieces, in accordance with at least one embodiment;

FIG. 2A shows a side elevation view of a cutting device of the system of FIG. 1;

FIG. 2B shows a front elevation view of the cutting device of FIG. 2A;

FIG. 2C shows a perspective view of an outlet end of the cutting device of FIG. 2A;

FIG. 3 shows a perspective view of a twisted potato piece cut by the system of FIG. 1;

FIG. 4A shows a side elevation view of a cutting device in accordance with another embodiment;

FIG. 4B shows a front elevation view of the cutting device of FIG. 4A;

FIG. 4C shows a perspective view of an outlet end of the cutting device of FIG. 4A;

FIG. 5 shows a perspective view of a system for cutting twisted potato pieces, in accordance with another embodiment;

FIG. 6 shows a perspective view of a system for cutting twisted potato pieces, in accordance with another embodiment;

FIG. 7A shows a side elevation view of a cutting device of the system of FIG. 6; and

FIG. 7B shows a front elevation view of the cutting device of FIG. 7A.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

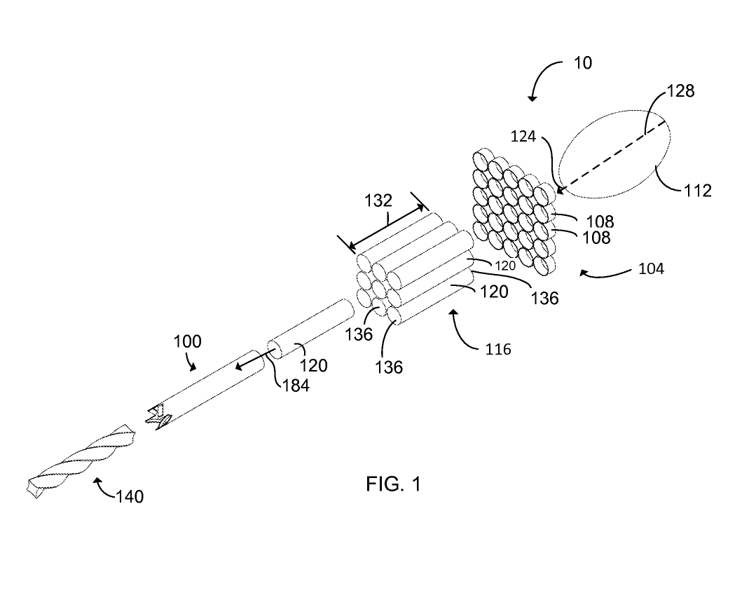

Reference is first made to FIG. 1, which shows an exemplary system 10 including a cutting device 100 in accordance with at least one embodiment. Cutting device 100 may be used to cut an elongate twisted food piece from a food product. For clarity of illustration, the examples described herein will refer to a potato as an exemplary food product. However, any suitable food product, such as another vegetable or fruit, may substitute potato in the described examples.

In the illustrated example, system 10 includes an array 104 of cutting rings 108 positioned upstream of cutting device 100. As shown, a potato 112 is propelled toward array 104 of cutting rings 108, which cut potato 112 into a corresponding array 116 of cylindrical potato pieces 120.

Potato 112 may be propelled toward array 104 of cutting rings 108 in any suitable manner, such as by direct mechanical force, or by a fluid (e.g. water or gas) conveyance system. For example, system 10 may further include a conduit (not shown) inside which array 104 and cutting device 100 may be positioned in series. In this case, potatoes 112 may be propelled through array 104 and cutting device 100 under the pressure of a fluid (e.g. water) flowing through the conduit.

Potato 112 is propelled in a direction 124 through array 104 of cutting rings 108. Preferably, a long axis 128 of the potato is substantially aligned with direction 124 as illustrated. This may permit array 116 to cut cylindrical potato pieces 120 having a length 132. In alternative embodiments, potato 112 may be propelled in a direction that forms a (non-zero) angle to the long axis 128 of potato 112. In some cases, this may permit more potato pieces 120 to be cut from potato 112 by array 104 of cutting rings 108.

Although potato pieces 120 of array 116 are all shown having planar ends 136 and the same length 132, in practice, the profile of ends 136 and length 132 of each potato piece 120 may depend upon the shape of the source potato 112, unless additional processing (e.g. cutting) is performed.

Preferably, cutting rings 108 in array 104 are positioned side-by-side and abutting one another, as shown. This may help to minimize waste formed from each potato 112 cut by array 104 of rings 108. Rings 108 in array 104 are shown arranged in a square grid pattern. In alternative embodiments, rings 108 in array 104 may be arranged in any other suitable pattern, such as a hexagonal grid (not shown). In some embodiments (not shown), cutting rings 108 in array 104 may be spaced apart from each other.

In the illustrated example, cylindrical potato pieces 120 are arranged in single file for passing through cutting device 100 one at a time, which cuts each potato piece 120 into a twisted potato piece 140. For example, where system 10 includes a surrounding conduit (not shown), as discussed above, the conduit may be narrowed between array 116 and cutting device 100 to a diameter of less than two cylindrical potato pieces 120. In alternative embodiments, cutting device 100 may support cutting a plurality of potato pieces 120 in parallel (i.e. at the same time), as will be discussed in more detail below.

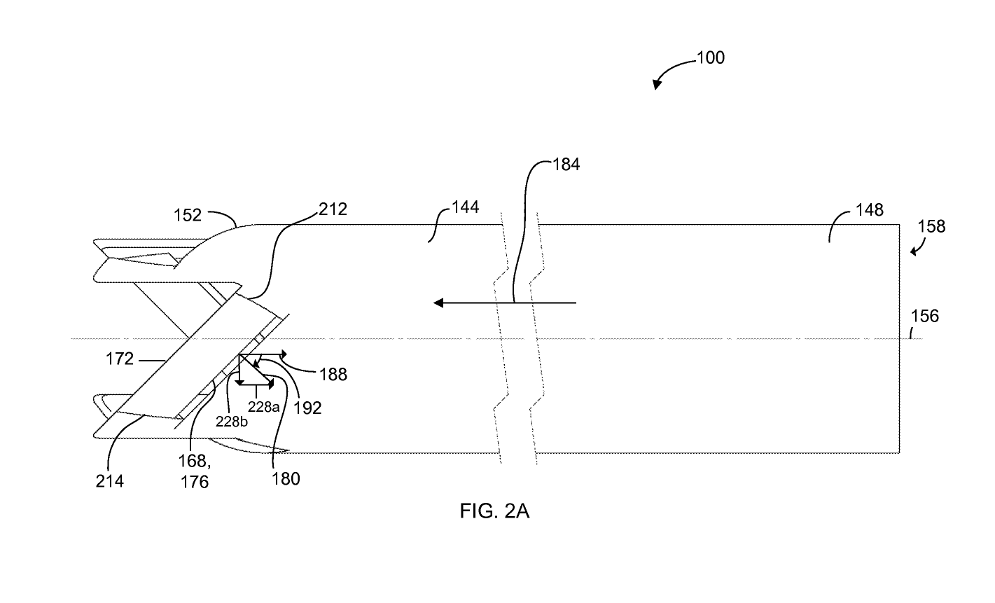

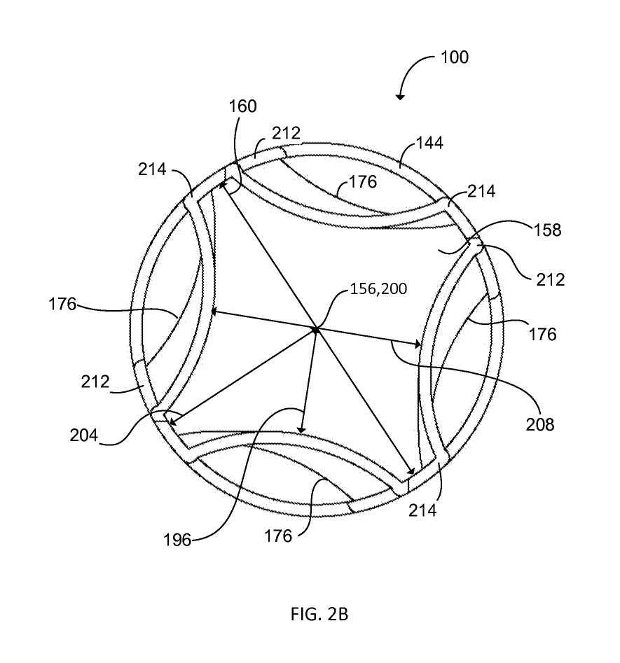

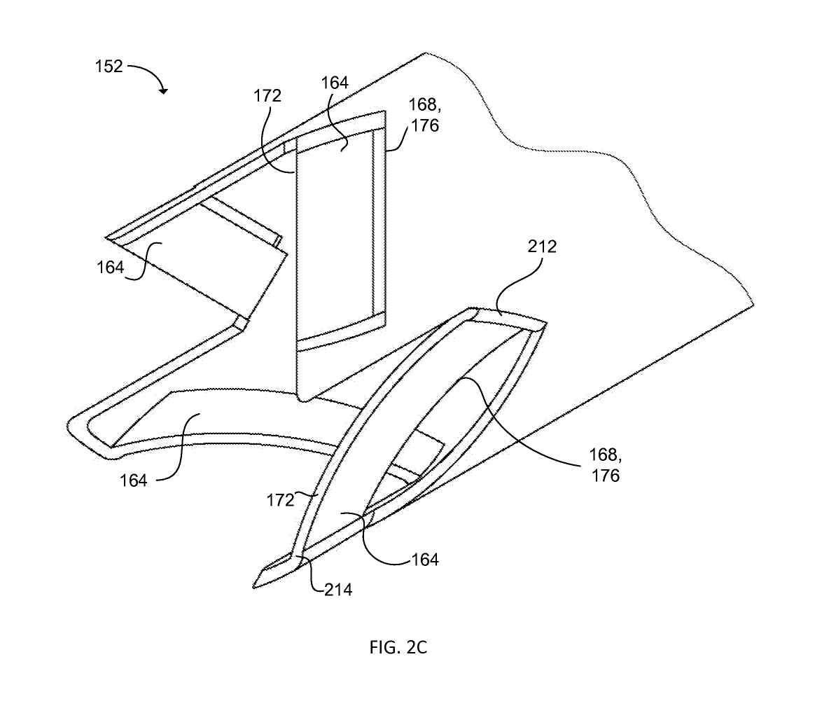

Reference is now made to FIGS. 2A-2C, which show a cutting device 100 in accordance with at least one embodiment. As shown, cutting device 100 includes a hollow tube 144 which extends in length from an inlet end 148 to an outlet end 152 in parallel with a longitudinal axis 156. Hollow tube 144 defines a passage (i.e. through-hole) that extends from the inlet end 148 to the outlet end 152 through which a potato piece 120 may pass for cutting into a twisted potato piece 140 (see FIG. 1). Preferably, the passage is a bore 158.

Reference is now made to FIGS. 1 and 2A-2C. Preferably, bore 158 of tube 144 is substantially cylindrical from inlet end 148 downstream toward outlet end 152, as shown, for receiving a cylindrical potato piece 120. In this case, a diameter 160 of bore 158 may be slightly larger than cylindrical potato piece 120, which may permit potato piece 120 to travel through bore 158 unobstructed. Preferably, diameter 160 is between 6 mm to 20 mm, and more preferably between 12 mm and 16 mm.

In the illustrated example, cutting device 100 includes a plurality of cutting blades 164. As shown, cutting blades 164 are preferably integrally formed with hollow tube 144 at outlet end 152 thereof. For example, cutting blades 164 may be formed by punching portions of hollow tube 144 at outlet end 152. In alternative embodiments, cutting blades 164 may be coupled to hollow tube 144 in any suitable fashion, such as by welds, bolts, or rivets at any suitable position downstream of inlet end 148. In some cases, cutting blades 164 may be mounted to hollow tube 144 in a manner that permits removable for replacement or repair, e.g. if damaged or dulled.

As shown, each cutting blade 164 includes an upstream side 168 and a downstream side 172. Preferably, upstream side 168 forms a blade edge 176 that faces toward inlet end 148. As used herein and in the claims, a blade edge 176 is said to “face” toward inlet end 148 where the normal 180 of the blade edge 176 forms an angle 192 with the upstream direction 188 of less than 90 degrees. This may permit the blade edge 176 of each cutting blade 164 to cut into a potato piece 120 that travels downstream through hollow tube 144.

At least a portion of the blade edge 176 of each cutting blade 164 extends into bore 158 (i.e. in the path of a potato piece 120) for slicing off a portion of a potato piece 120 passing through hollow tube 144. For example, the shortest distance 196 between each blade edge 176 and a center 200 of bore 158 may be less than the radius 204 of bore 158 (or more generally, less than half of the width of bore 158).

In the illustrated example, cutting device 100 includes four cutting blades 164 distributed evenly about center 200 of bore 158, such that each cutting blade 164 is diametrically opposed to another cutting blade 164. In this case, the shortest distance 208 between the blade edges 176 of opposite cutting blades 164 may be less than the diameter 160 of bore 158 (or more generally, less than half of the width of bore 158). In alternative embodiments, cutting device 100 may include any suitable number of cutting blades 164 (e.g. from 2 to 20 cutting blades, or more preferably from 3 to 8 cutting blades). Further, cutting blades 164 may be evenly or unevenly distributed about center 200 of bore 158 (i.e. about longitudinal axis 156) for cutting any desired cross-sectional shape into a potato piece 120.

Each blade 164 includes an upstream end 212 and a downstream end 214. In the illustrated example, each blade 164 bends inwardly into bore 158 between the upstream and downstream ends 214 of that blade 164. This may form a blade edge 176 that follows a convex path relative to the center 200 of the bore 158, as shown. In alternative embodiments, a blade 164 may extend along any suitable path between upstream and downstream ends 214. For example, a blade 164 may extend linearly between upstream and downstream ends 212 and 214 across a portion of bore 158 to provide blade edge 176 that follows a linear path.

Further, blade edges 176 may have any suitable edge shape. For example, any one or more of blade edges 176 may be straight edged (as shown), wavy, or jagged for example to impart a corresponding shape to the cross-sectional profile of a potato piece 120.

Referring to FIGS. 2A-C, the upstream end 212 of each blade edge 176 is adjacent to and spaced apart from the downstream end 214 of an adjacent blade edge 176 when viewed in profile (i.e. from the perspective of FIG. 2B which is viewed in the direction of the longitudinal axis 156). Further, each blade edge 176 is positioned about bore 158 so as not to overlap another blade edge 176 when viewed in profile. This may permit blades 164 to cut spaced apart profile cuts into a potato piece 120 to form a new cross-sectional profile, where the profile cuts are connected by pre-existing edge profiles.

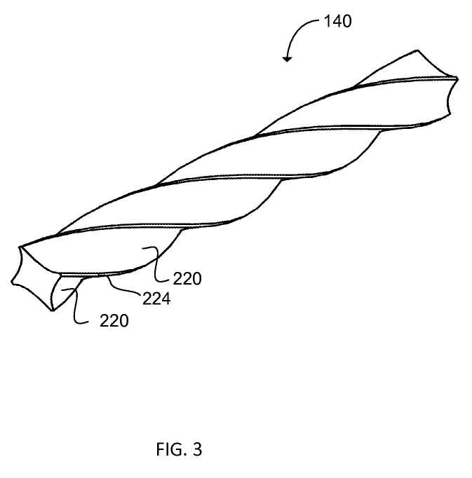

Reference is now made to FIGS. 1-3, where FIG. 3 shows a twisted potato piece 140 cut by cutting device 100. In the illustrated example, each side face 220 of twisted potato piece 140 has been cut by a different cutting blade 164, and adjacent side faces 220 are spaced apart and joined by a connecting face 224. In this example, connecting faces 224 are portions of the exterior surface of the original potato piece 120 that was not removed by cutting blades 164.

In alternative embodiments, the upstream end 212 of each blade edge 176 may be positioned to overlap the downstream end 214 of an adjacent blade edge 176 when viewed in profile. In other embodiments, each blade edge 176 may be positioned about bore 158 to overlap another blade edge 176 when viewed in profile. In either of these cases, blades 164 in combination may remove all exterior faces of a potato piece 120 to define the entire cross-sectional profile of the resulting twisted potato piece 140.

As described in more detail below, the cutting device 100 preferably imparts axial rotation upon a potato piece 120 as the potato piece 120 passes through hollow tube 144 in order to form a twisted potato piece 140 having a cross-sectional profile that rotates (i.e. twists) along the length of the potato piece 140 as shown. Preferably, hollow tube 144 (including cutting blades 164 attached thereto) remains stationary (i.e. does not move or rotate), and instead the orientation of blades 164 impart rotation upon a potato piece 120 during cutting.

In the illustrated example, a potato piece 120 moves axially through hollow tube 144 in a downstream direction 184 parallel to the longitudinal axis 156 of hollow tube 144. During cutting, each blade 164 applies a reactionary force to the potato piece 120 in the direction 180 normal to the cutting edge 176 of the blade 164. As shown, direction 180 is a vector having orthogonal components 228a and 228b. Directional component 228a of the reactionary force is parallel with the upstream direction 188 and opposite the downstream direction 184, and therefore acts to slow the downstream movement of the potato piece 120. Directional component 228b of the reactionary force is tangential to bore 158 and acts to rotate the potato piece 120 in the tangential direction 228b during cutting.

The magnitudes of directional components 228a and 228b depend upon the angle 192 that the normal 180 of blade edge 176 forms with the upstream direction 188. If angle 192 is 0 degrees, then directional component 228b is zero and no rotation is imparted upon the potato piece 120 by that blade edge 176. On the other hand, if angle 192 is 90 degrees, then the upstream component 228a is zero and the blade edge 176 may not cut into the potato piece 140. Preferably, angle 192 is greater than 0 and less than 90, and more preferably between 20 degrees and 70 degrees, and most preferably between 30 degrees and 60 degrees. In the illustrated example, angle 192 is approximately 45 degrees.

In the illustrated example, angle 192 is formed by the angularity of the cutting blade 164. As shown, for each cutting blade 164, the upstream end 212 is axially position further upstream than the downstream end 216. In this way, the blade edge 176 of each cutting blade 164 faces tangentially to the bore 158. Preferably, the blade edges 176 of all the cutting blades 164 face the same circular direction (i.e. clockwise or counterclockwise) when viewed in profile (as in FIG. 2B). This may permit each cutting blade 164 to impart rotation upon the potato piece 120 in the same circular direction.

In other embodiments, some cutting blades 164 may face opposite circular directions. Cutting blades 164 that face opposite directions may cancel out some or all of the rotational forces they impart upon the potato piece 120. This may provide enhanced control over the rotational speed of the potato piece 120 during cutting, and therefore the frequency at which the cross-sectional profile rotates in the resulting twisted potato piece 140. For example, three cutting blades 164 may face in one circular direction, and one cutting blade may face in the other circular direction. In any case, the cutting blades 164 preferably provide a non-zero net rotary force upon the potato piece 120 to rotate the potato piece 120 during cutting.

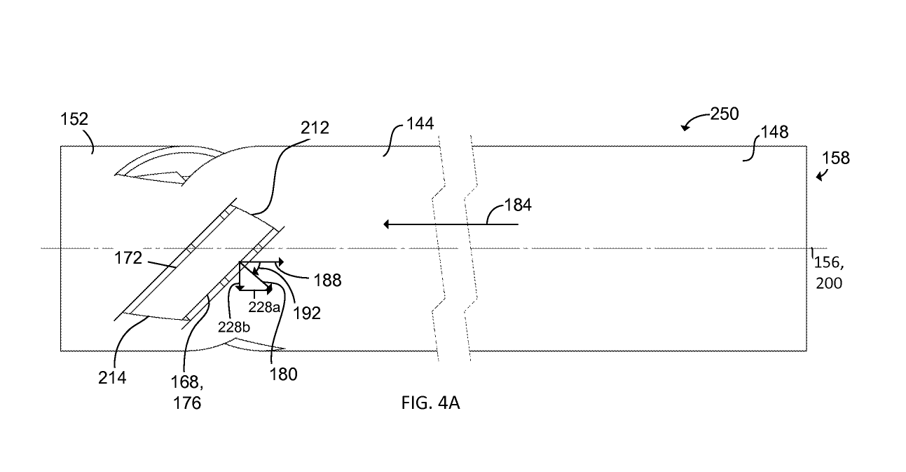

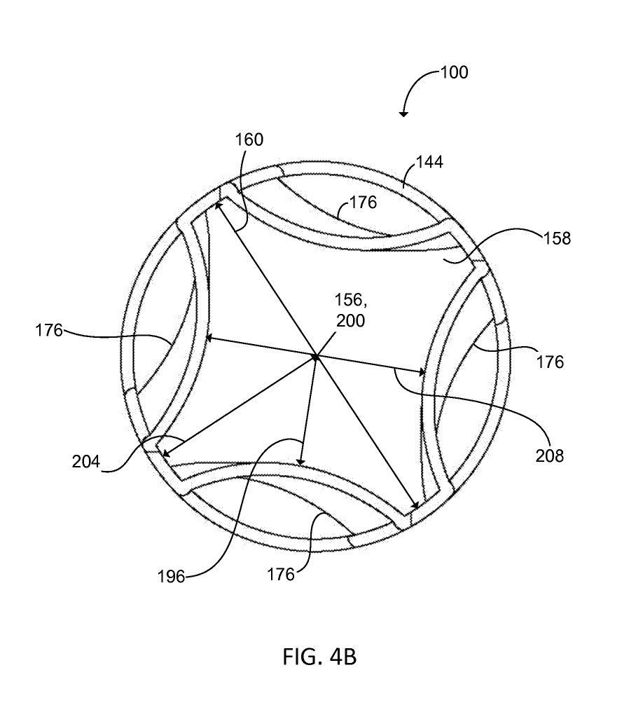

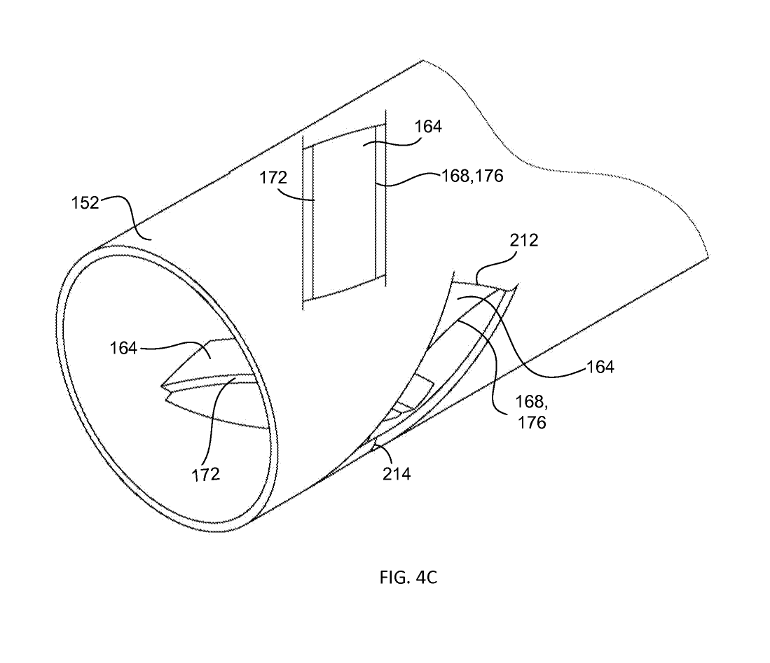

In the illustrated example, cutting blades 164 are coupled to hollow tube 144 at the outlet end 152 of the hollow tube 144. In alternative embodiments, cutting blades 164 may be positioned intermediate the inlet and outlet ends 148 and 152 of hollow tube 144. FIGS. 4A-4C show a cutting device 250 in accordance with another embodiment, where like part numbers refer to like parts in the previous figures. Cutting device 250 is similar to cutting device 100 in many respects, except that the cutting blades 164 are positioned upstream of the outlet end 152.

Returning to FIG. 1, system 10 as shown includes an array 104 of cutting rings 108 for cutting cylindrical potato pieces 120 which are directed through a cutting device 100 to produce twisted potato pieces 140. In alternative embodiments, array 104 of cutting rings 108 may be substituted by a different cutting apparatus which may cut potato pieces 120 having a different (i.e. non-circular) cross-sectional shape from a potato 112.

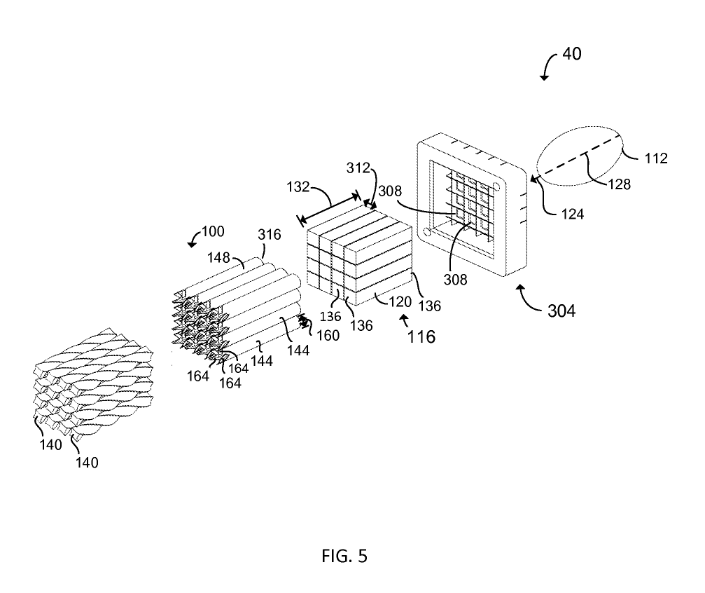

Reference is now made to FIG. 5, where like part numbers refer to like parts in the previous figures, and where a system 40 is shown in accordance with another embodiment. System 40 is similar to system 10 in many respects, except for example that system 40 includes an array 304 of sixteen straight blades 308 for cutting an array 116 of potato pieces 120 having square cross-sectional shapes.

In the example shown, array 304 includes a plurality of straight blades 308 arranged in a grid formation for cutting a potato 112 into a plurality of potato pieces 120, where each potato piece 120 is cut with a square cross-sectional shape. The number of blades 308 in the array 304, and the spacing between the blades 308 may be selected to cut potato pieces 120 of any desired dimension.

As exemplified, system 40 includes a cutting device 100 having an array of hollow tubes 144 (each having respective cutting blades 164) for simultaneously cutting the plurality of potato pieces 120. As shown, hollow tubes 144 of cutting device 100 may be arranged in a grid formation in alignment with the corresponding array 116 of potato pieces 120 to be cut.

Reference is now made to FIG. 2B and 5. In some embodiments, the width 312 of each potato piece 120 may be less than a diameter 160 of the bore 158 of the corresponding hollow tube 144. In this case, the potato piece 120 may enter the hollow tube 144 freely, and be cut into a twisted potato piece 140 by cutting blades 164. Preferably, hollow tube 144 has a bore 158 with a round (e.g. circular or oval) cross-sectional profile. This may prevent the sidewalls of the bore 158 from obstructing the rotation of the potato piece 120 during cutting. In alternative embodiments, hollow tube 144 has a bore 158 with a non-round (e.g. square or rectangular) cross sectional profile. In this case, the shortest width 160 of the bore 158 is preferably greater than the largest width 312 (e.g. measured across opposite corners) of the potato piece 120 to permit the potato piece 120 to rotate without obstruction during cutting.

In some embodiments, the width 312 of each potato piece 120 may be greater than a diameter 160 of the bore 158 of the corresponding hollow tube 144. In this case, the inlet end 148 of the hollow tube 144 may define a cutting edge 316 for cutting the potato piece 120 down to size for passage through the hollow tube 144. The cutting edge 316 may be integrally formed with the inlet end 148 of the hollow tube 144 or suitable coupled thereto (e.g. by welds, screws, bolts, or rivets).

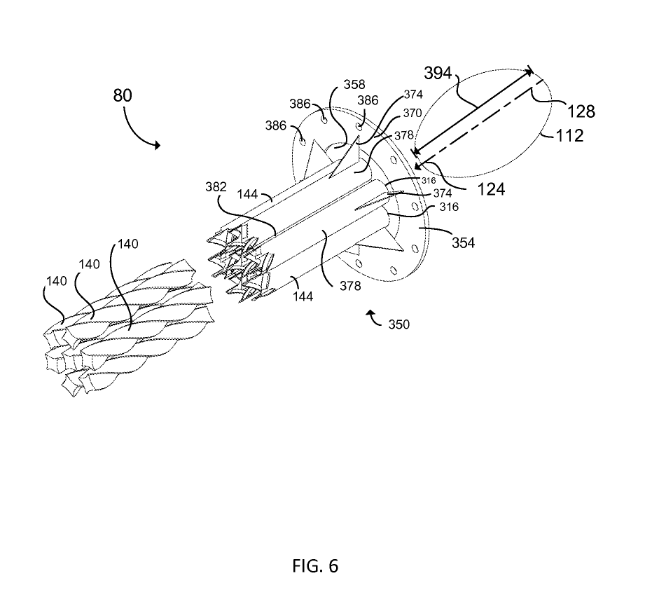

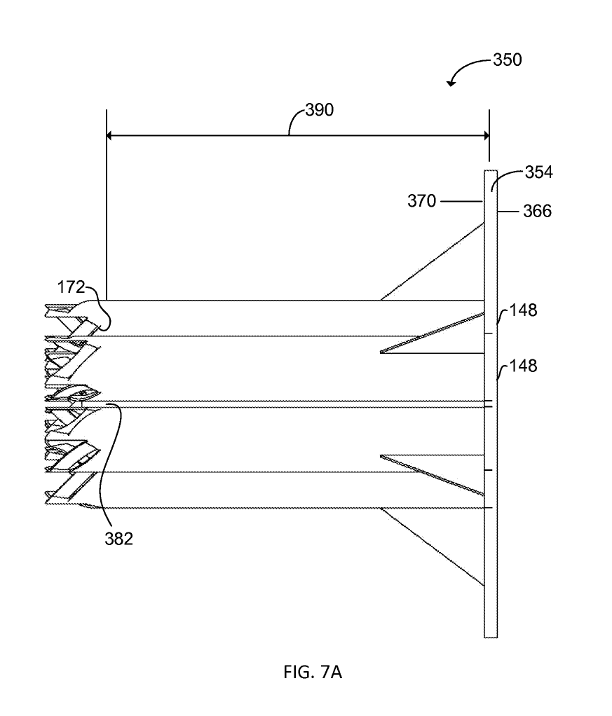

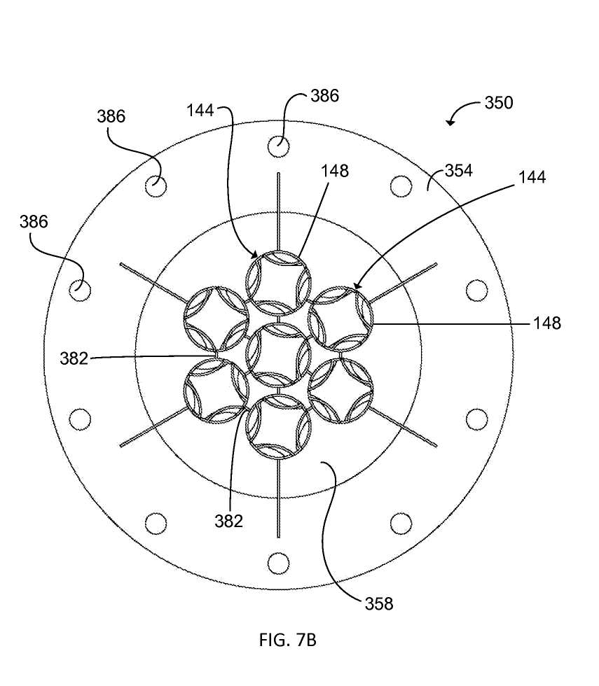

Reference is now made to FIGS. 6 and 7A-7B, where like part numbers refer to like parts in the previous figures, and where a system 80 and cutting device 350 are shown in accordance with another embodiment. System 80 is similar to system 10 in many respects, except for example that cutting device 350 includes a plurality of hollow tubes 144 mounted to a common base 354.

In the example shown, cutting device 350 includes a base 354 that defines an interior opening 358, and a plurality of hollow tubes 144 mounted to the base 354 in alignment with the opening 358. As shown, hollow tubes 144 may be mounted in parallel with each other, and side-by-side. The inlet end 148 of each hollow tube 144 may be aligned in a plane parallel to the cross-sectional plane of the opening 358. Alternatively, one or more of hollow tubes 144 may be staggered longitudinally relative to the other hollow tubes 144.

Preferably, the inlet end 148 of each hollow tube 144 is aligned within the perimeter (e.g. circumference, if the opening 358 is circular as shown) of opening 358 when viewed in profile normal to the cross-sectional plane of the opening 358 (i.e. from the perspective of FIG. 7B). This may prevent base 354 from obstructing the inlet ends 148 of the hollow tubes 144.

Base 354 is shown including an upstream side 366 and a downstream side 370. Each hollow tube 144 may extend through opening 358 and the inlet end 148 of each hollow tube 144 may be aligned in a common plane with the upstream side 366 of base 354. In alternative embodiments, one or more of hollow tubes 144 may have an inlet end 148 positioned downstream or upstream of the upstream side 366 of base 354. For example, a hollow tube 144 may have an inlet end 148 aligned in a common plane with the downstream side 366 of base 354.

Hollow tubes 144 may be mounted to base 354 in any suitable fashion. In the illustrated example, a support plate 374 is connected in a suitable manner (e.g. by welds, rivets or screws) to the downstream side 370 of base 354, and to an exterior sidewall 378 of each hollow tube 144. Further, each hollow tube 144 is shown connected to each adjacent hollow tube 144 by a support plate 382. Support plates 374 and 382 may rigidly connect hollow tubes 144 to each other and to base 354 to form a rigid unit. This may permit hollow tubes 144 to withstand impact forces from the potatoes 112 without breaking formation.

Preferably, base 354 may be mounted to a fluid conduit (not shown) of a hydraulic conveyor (not shown). In the illustrated example, base 354 includes a circular array of through holes 386 for receiving a circular array of bolts for connecting base 354 to an opposing flange (not shown) of the fluid conduit. In alternative embodiments, base 354 may be mounted to the fluid conduit in any other suitable fashion, such as by welding.

In the example shown, cutting device 350 cuts a whole potato 112 into a plurality of twisted potato pieces 140. In this case, the inlet end 148 of each hollow tube 144 preferably defines a cutting edge 316 for first cutting the potato 112 into a plurality of potato pieces 120. Preferably, for each hollow tube 144, the axial distance 390 between the inlet end 148 and the downstream side 172 of each cutting blade 164 is greater than or equal to an expected axial length 394 of the potato 112 being cut. This may permit each hollow tube 144 to cut a potato piece 120 from the full axial length of the potato 112 before the potato piece 120 is rotated by the cutting blades 164. Otherwise, a potato piece 120 may be still connected to an uncut upstream end of the potato 112 when cutting blades 164 exert a rotary force upon the potato piece 120, which may result in the potato piece 120 fracturing from the uncut upstream end. This may or may not be desirable depending upon whether an unfinished end cut is desired for the resulting twisted potato piece 140.

It will be appreciated that the minimum axial distance 390 for hollow tubes 144 to cut complete potato pieces 120 before cutting by blades 164 begins, will depend upon the length of the potato 112 being cut. In this regard, a longer axial distance 390 may provide more flexibility for cutting different lengths of potatoes 112. Preferably, axial distance 390 is between 50 mm and 125 mm, and more preferably between 90 mm and 100 mm.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A cutting device for cutting twisted-shape food pieces, the cutting device comprising:
at least one tube, the tube having an open inlet end and an open outlet end,
wherein the tube defines a longitudinal passage extending from the inlet end to the outlet end; and
at least three cutting blades coupled to the tube downstream of the inlet end of the tube,
wherein each cutting blade includes a blade edge facing the inlet end, and
wherein each blade edge extends from an upstream edge end to a downstream edge end across a portion of the bore.

2. The cutting device of claim 1, wherein the passage is cylindrical.

3. The cutting device of claim 1, wherein the cutting blades of the tube are coupled to the downstream end of the tube.

4. The cutting device of claim 1, wherein the cutting blades of the tube are integrally formed with the tube.

5. The cutting device of claim 4, wherein the cutting blades of the tube are formed from an inwardly punched portion of a sidewall of the tube.

6. The cutting device of claim 1, wherein each blade edge of each blade of the tube has a convex shape relative a longitudinal axis of the tube.

7. The cutting device of claim 1, wherein a downstream distance between the inlet end and the cutting blades is between 50 mm and 125 mm.

8. The cutting device of claim 1, wherein the at least one tube includes at least six tubes arranged in parallel side-by-side.

9. The cutting device of claim 8, wherein the inlet end of each tube is aligned in a common plane.

10. The cutting device of claim 2, wherein the passage of the tube has a diameter of between 6 mm and 20 mm.

11. The cutting device of claim 1, wherein each blade edge faces tangentially in a same circular direction.

12. The cutting device of claim 2, wherein at least a portion of each blade edge is spaced apart from the longitudinal axis of the tube by less than a radius of the passage of the tube.

13. The cutting device of claim 1, further comprising:
a base defining an interior opening;
wherein each of the at least one tube is coupled to the base, and
wherein the inlet end of each tube faces the opening.

14. The cutting device of claim 13, further comprising:
at least one mounting plate, the mounting plate having first and second edges, the first edge connected to the tube, and the second edge connected to the base.

15. The cutting device of claim 13, wherein the base further defines a plurality of spaced apart mounting holes distributed around a periphery of the interior opening.

16. The cutting device of claim 13, wherein each tube extends through the interior opening.

17. The cutting device of claim 16, wherein the base includes an upstream side and a downstream side, and wherein an inlet end of each tube is axially aligned with the upstream side of the base.

18. The cutting device of claim 1, wherein the inlet end of the tube defines an inlet cutting edge.

19. A method of cutting an elongate food piece using a cutting device,
the method comprising:
moving the food piece from an inlet end of a hollow tube of the cutting device toward an outlet end of the hollow tube, and
cutting the food piece with a plurality of cutting blades mounted to the hollow tube, wherein the cutting blades are positioned downstream of the inlet end, wherein the cutting blades cut the food piece to define a new cross-sectional shape of the food piece, wherein the cutting blades apply reactionary forces to the food piece, the reactionary forces having tangential force components, wherein the reactionary forces imparted by the cutting blades rotate the food piece about a longitudinal axis of the food piece during said moving step.

20. The method of claim 19, further comprising:
moving a food product through the inlet end, whereby the inlet end cuts the food product to form the food piece.

21. The method of claim 19, wherein the food piece is cylindrical, and the new cross-sectional shape has a plurality of sides.
